(19) United States
(12) Patent Application Publication
(10) Pub. No.: US 2025/0161891 A1
(43) Pub. Date: May 22, 2025

(54) Raw Material Mixing Device for Slurry Preparation

(71) Applicant: LG Energy Solution, Ltd., Seoul (KR)

(72) Inventors: Jae Pil Koo, Daejeon (KR); Sung Jong Shin, Daejeon (KR); Woong Ju Bang, Daejeon (KR); Jae Huoung Son, Daejeon (KR)

(73) Assignee: LG Energy Solution, Ltd., Seoul (KR)

(21) Appl. No.: 18/841,586

(22) PCT Filed: May 18, 2023
(86) PCT No.: PCT/KR2023/006721

§ 371 Date: Aug. 26, 2024

(30) Foreign Application Priority Data
May 20, 2022 (KR) 10-2022-0061720

(51) Int. Cl. B01F 23/70; B01F 23/50

(52) U.S. Cl. CPC B01F 23/713; B01F 23/565

(57) ABSTRACT

A raw material mixing device for slurry preparation according to one example of the disclosure a mixer body in which powder-containing raw materials for forming a slurry are mixed, a powder input part provided in the mixer body and having a first passage through which the powder moves to the mixer body, and a pulverization part including a plurality of mesh members disposed apart from each other in the first passage and operation units coupled to the respective mesh members and moving the respective mesh members in preset operating directions, and provided to pulverize the powder passing through the first passage while the respective mesh members move in directions different from each other.

### CROSS-REFERENCE TO RELATED APPLICATIONS

The present application is a national phase entry under 35 U.S.C. § 371 of International Application No. PCT/KR2023/006721, filed May 18, 2023, published in Korean, which claims priority from Korean Patent Application No. 10-2022-0061720 dated May 20, 2022, all of which is incorporated herein by reference in their entireties.

### FIELD OF THE INVENTION

The present invention relates to a raw material mixing device for slurry preparation, and particularly, relates to a raw material mixing device for slurry preparation capable of improving a slurry preparation process efficiency by pulverizing powder introduced into a mixer body in a slurry preparation process and introducing the powder into the mixer body in a powder form.

### BACKGROUND OF THE INVENTION

Processes for manufacturing an electrode of a secondary battery are divided into a slurry manufacturing process, a process of coating a slurry on a current collector, a rolling process, a slitting process, and a drying process.

The slurry is a mixture of an active material, a conductive material, a binder, and a solvent. The active material and the conductive material are dry-mixed in powder forms. Thereafter, the active material and the conductive material are wet-mixed in the solvent in which the binder is dissolved to form the slurry.

Various active materials are used according to the product type of the secondary battery, where it has each of different characteristics depending on the type of the active material. Depending on the type of active material, there are differences in the time when the respective raw materials are introduced into a mixing device, the time when the respective raw materials are mixed in a mixing device, and the like. Accordingly, there has been a problem that in the active material taking a long time for introduction to the mixing device, productivity is lowered.

FIG. 1 is a diagram for explaining a conventional raw material mixing device for slurry preparation.

Referring to FIG. 1, a mixer (11) is provided with a plurality of input parts (12, 13, 15) into which each raw material constituting the slurry is introduced, and an outlet (17) through which the slurry is discharged. Conventionally, in order to solve agglomeration of active materials, a mesh (16) was installed in the active material input part (15).

However, when the active material is agglomerated in large lumps, the agglomerated active material does not pass through the mesh (16), and thus an operator manually crushes the active material as agglomerated in lumps, whereby there is a problem that the input time of the active material increases.

### BRIEF SUMMARY OF THE INVENTION

The present invention is intended to provide a raw material mixing device for slurry preparation capable of preventing agglomeration of powder introduced into a mixer body in a slurry preparation process.

A raw material mixing device for slurry preparation according to an example of the present invention comprises a mixer body in which powder-containing raw materials for forming a slurry are mixed, a powder input part provided in the mixer body and having a first passage through which the powder moves to the mixer body, and a pulverization part including a plurality of mesh members disposed apart from each other in the first passage and operation units coupled to the respective mesh members and moving the respective mesh members in preset operating directions, and provided to pulverize the powder passing through the first passage while the respective mesh members move in directions different from each other.

Also, each mesh member may be provided in the powder input part to be movable in one direction of a longitudinal direction of the first passage, a width direction of the first passage, and a circumferential direction of the first passage.

In addition, the plurality of mesh members may comprise a first mesh member having a network structure composed of first openings and a second mesh member having a network structure composed of second openings having an opening area smaller than the first opening area, and the second mesh member may be installed in the first passage so that the powder passing through the first mesh member passes.

As one example, the plurality of mesh members may comprise first and second mesh members, where the first and second mesh members may each be installed in the powder input part to be movable in directions opposite to each other along the longitudinal direction of the first passage, and an interval between the first and second mesh members may be adjusted. To this end, the pulverization part may comprise a first guide rail guiding movement of the first mesh member and installed on the inner side surface of the powder input part in the longitudinal direction of the first passage, a first operation member providing a driving force to the first mesh member, a second guide rail guiding movement of the second mesh member, disposed apart from the first guide rail, and installed on the inner side surface of the powder input part in the longitudinal direction of the first passage, and a second operation member providing a driving force to the second mesh member. Also, the first operation member and the second operation member may operate the first mesh member and the second mesh member, respectively, so that they move in directions different from each other. In such a structure, the interval between the first and second mesh members may be adjusted. In addition, while the interval between the first mesh member and the second mesh member widens or narrows, it is possible to sieve the powder passing through the first mesh member and the second mesh member.

As another example, the plurality of mesh members may comprise first and second mesh members, where the first and second mesh members may each be installed in the powder input part to be reciprocally movable in the width direction of the first passage in a first width section and a second width section divided orthogonally to each other in the first passage, and the two mesh members may each be moved in the width direction of the first passage so that operating directions are parallel to each other, but are orthogonal to each other. To this end, the pulverization part may comprise a first width direction guide member guiding movement of the first mesh member and installed on the inner side surface of the powder input part in the first width section, a first operation member providing a driving force to the first mesh member, a second width direction guide member guiding movement of the second mesh member and installed on the inner side surface of the powder input part in the second width section, and a second operation member providing a driving force to the second mesh member. Also, the first operation member may operate the first mesh member to reciprocate the first width section, and the second operation member may operate the second mesh member to reciprocate the second width section. In addition, the first operation member and the second operation member may allow the first mesh member to reciprocate in the first width section and simultaneously the second mesh member to reciprocate in the second width section. Accordingly, while the first mesh member and the second mesh member are moved in directions orthogonal to each other, it is possible to sieve the powder passing through the first passage.

In another example, the plurality of mesh members may comprise first and second mesh members, where the first and second mesh members may each be installed in the powder input part to be rotatable in directions opposite to each other along the circumferential direction of the first passage, and the two mesh members may be rotated in directions parallel to each other, but opposite to each other. To this end, the pulverization part may comprise a first rotation guide member guiding rotation of the first mesh member and installed on the inner side surface of the powder input part along the circumference of the first passage, a first operation member providing a rotational force to the first mesh member so that the first mesh member is rotated in a first rotation direction as preset, a second rotation guide member guiding rotation of the second mesh member and installed on the inner side surface of the powder input part to be disposed apart from the first rotation guide member side by side, and a second operation member providing a rotational force to the second mesh member so that the second mesh member is rotated in a second rotation direction opposite to the first rotation direction. In such a structure, the first operation member and the second operation member may simultaneously rotate the first mesh member and the second mesh member in directions different from each other, and it is possible to sieve the powder passing through the first passage, while the first mesh member and the second mesh member are rotated in directions opposite to each other.

As another example, the plurality of mesh members may comprise a first mesh member installed in the powder input part to be movable in the longitudinal direction of the first passage, and a pair of second mesh members disposed apart from the first mesh member in the longitudinal direction of the first passage, but each installed in the powder input part to be reciprocally movable in the width direction of the first passage in a first width section and a second width section divided orthogonally to each other in the first passage. Also, the pair of second mesh members may comprise a 2a mesh member reciprocating in the first width section and a 2b mesh member reciprocating in the second width section. In addition, the pulverization part may comprise a first guide rail guiding movement of the first mesh member and installed on the inner side surface of the powder input part in the longitudinal direction of the first passage, a first operation member providing a driving force to the first mesh member, a 2a width direction guide member guiding movement of the 2a mesh member and installed on the inner side surface of the powder input part in the first width section of the first passage, a 2a operation member providing a driving force to the 2a mesh member, a 2b width direction guide member guiding movement of the 2b mesh member and installed on the inner side surface of the powder input part in the second width section, and a 2b operation member providing a driving force to the 2b mesh member. In such a structure, the first operation member may reciprocate the first mesh member along the first guide rail in the longitudinal direction of the first passage, and the 2a operation member and the 2b operation member may reciprocate the 2a mesh member and the 2b mesh member in directions parallel to each other, but orthogonal to each other. In such a structure, as the first operation member moves the first mesh member in the longitudinal direction of the first passage, it is possible to adjust the interval between the first mesh member and the 2a mesh member, and it is possible to sieve the powder passing through the first passage while the distance is adjusted.

As another example, the plurality of mesh members may comprise a first mesh member installed in the powder input part to be movable in the longitudinal direction of the first passage, and a pair of second mesh members disposed apart from the first mesh member in the longitudinal direction of the first passage, but installed in the powder input part to be rotatable along the circumference of the first passage. Also, the pair of second mesh members may comprise a 2a mesh member and a 2b mesh member. In addition, the pulverization part may comprise a first guide rail guiding movement of the first mesh member and installed on the inner side surface of the powder input part in the longitudinal direction of the first passage, a first operation member providing a driving force to the first mesh member, a 2a rotation guide member guiding rotation of the 2a mesh member and installed on the inner side surface of the powder input part along the circumference of the first passage, a 2a operation member providing a rotational force to the 2a mesh member so that the 2a mesh member rotates in a first rotation direction as preset, a 2b rotation guide member guiding rotation of the 2b mesh member, disposed apart from the 2a rotation guide member side by side, and installed on the inner side surface of the powder input part along the circumference of the first passage, and a 2b operation member providing a rotational force to the 2b mesh member so that the 2b mesh member rotates in a second rotation direction opposite to the first rotation direction. In such a structure, the first operation member may reciprocate the first mesh member along the first guide rail in the longitudinal direction of the first passage, and the 2a operation member and the 2b operation member may operate the 2a mesh member and the 2b mesh member to rotate in directions parallel to each other, but opposite to each other. In such a structure, as the first operation member moves the first mesh member in the longitudinal direction of the first passage, it is possible to adjust the interval between the first mesh member and the 2a mesh member, and it is possible to sieve the powder passing through the first passage while the distance is adjusted.

As described above, the raw material mixing device for slurry preparation according to one example of the present invention has the following effects.

In the slurry preparation process, the agglomerated powder may be pulverized so that the powder introduced into a mixer body is introduced in the form of powder. Accordingly, it is possible to uniformize the powder particles introduced into the slurry preparation process, and by shortening the powder input time, it is possible to improve the slurry preparation process efficiency.

In addition, as the powder is introduced into the mixer body in the form of powder without being agglomerated, the input speed of the powder and the input amount according to the input time are accurately calculated, whereby it is possible to improve formulation precision of the raw materials constituting the slurry

### BRIEF DESCRIPTION OF THE DRAWINGS

FIG. 1 is a diagram for explaining a conventional raw material mixing device for slurry preparation.

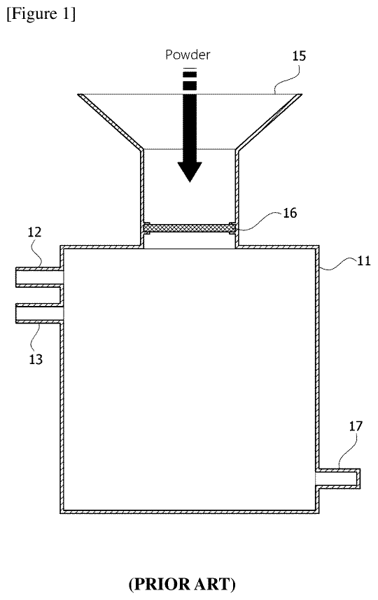

FIG. 2 schematically illustrates a cross-sectional diagram that a pulverization part according to one example of the present invention is installed in a mixer body.

FIG. 3 is a diagram for schematically explaining the configuration and operating state of a pulverization part according to a first example of the present invention.

FIGS. 4 and 5 are diagrams for schematically explaining the configuration and operating state of a pulverization part according to a second example of the present invention.

FIGS. 6 and 7 are diagrams for schematically explaining the configuration and operating state of a pulverization part according to a third example of the present invention.

FIG. 8 is a diagram for schematically explaining the configuration and operating state of a pulverization part according to a fourth example of the present invention.

FIG. 9 is a diagram for schematically explaining the configuration and operating state of a pulverization part according to a fifth example of the present invention.

### DETAIED DESCRIPTION

Hereinafter, a raw material mixing device for slurry preparation according to one example of the present invention will be described in detail with reference to the accompanying drawings.

In addition, regardless of the reference numerals, the same or corresponding components are given by the same or similar reference numerals, duplicate descriptions thereof will be omitted, and for convenience of explanation, the size and shape of each component member as shown can be exaggerated or reduced.

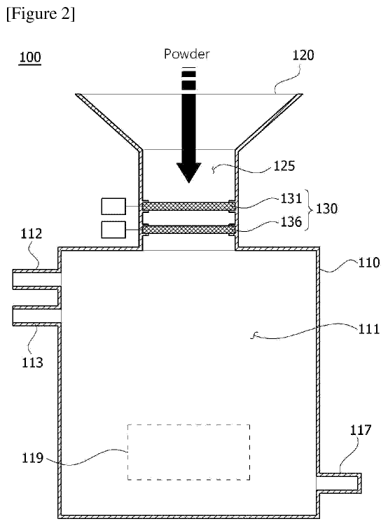

FIG. 2 schematically illustrates a cross-sectional diagram that a pulverization part according to one example of the present invention is installed in a mixer body.

Referring to FIG. 2, a raw material mixing device (100) for slurry preparation according to one example of the present invention comprises a mixer body (110) in which powder-containing raw materials for forming a slurry are mixed. The mixer body (110) may comprise a mixing space (111) in which the raw materials are accommodated to be mixed, and a mixing device (119) provided in the mixing space (111). The mixing device (119) may be composed of various types of devices (e.g., rotating bodies such as stirring blades) capable of forming the slurry using the active material powder.

Also, the raw material mixing device (100) for slurry preparation comprises a powder input part (120) provided on the mixer body (110) and having a first passage (125) through which the powder moves to the mixer body (100).

In addition, the raw material mixing device (100) for slurry preparation comprises a pulverization part (130) including a plurality of mesh members (131, 136) disposed apart from each other in the first passage (125) and operation units (132, 137) coupled to the respective mesh members and moving the respective mesh members in preset operating directions, and provided to pulverize the powder passing through the first passage (125) while the respective mesh members (131, 136) move in directions different from each other.

Furthermore, each of the mesh members (131, 136) may be provided in the powder input part (120) to be movable in at least one direction of the longitudinal direction of the first passage (125), the width direction of the first passage, or the circumferential direction of the first passage.

In addition, the plurality of mesh members (131, 136) may comprise a first mesh member (131) having a network structure composed of first openings and a second mesh member (136) having a network structure composed of second openings having an opening area smaller than the first opening area, and the second mesh member (136) may be installed in the first passage (125) so that powder passing through the first mesh member (131) passes.

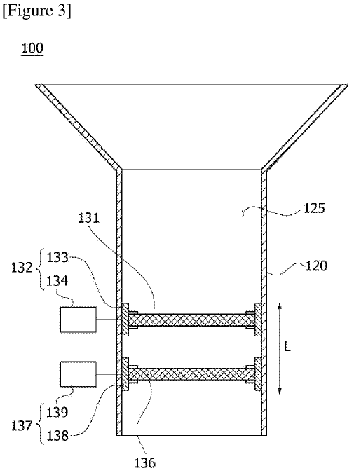

FIG. 3 is a diagram for schematically explaining the configuration and operating state of a pulverization part according to a first example of the present invention.

Referring to FIGS. 2 and 3, the raw material mixing device (100) for slurry preparation according to the first example comprises a mixer body (110), a powder input part (120), and a pulverization part (130). The raw material mixing device (100) for slurry preparation is a device in which the raw materials constituting the slurry are mixed. As described above, the slurry is a material that an active material, a conductive material, a binder, and a solvent are mixed. The active material and the conductive material are dry-mixed in the mixer body (110) in a powder form.

The mixer body (110) is provided with a plurality of input parts (112, 113, 120) into which the respective raw materials constituting the slurry are introduced, and an outlet (117) through which the slurry is discharged. In this example, for convenience of explanation, the input part into which the powder is introduced is referred to as the powder input part (120). In the slurry preparation process, the active material or the conductive material may correspond to the powder.

The powder input part (120) is coupled to the mixer body (110). The powder is introduced into the powder input part (120). A first passage (125) connected to the mixer body (110) is provided in the powder input part (120). Here, the first passage (125) refers to a passage through which the powder is moved to the mixer body (110).

The pulverization part (130) is installed in the first passage (125) provided in the powder input part (120). The pulverization part (130) pulverizes the powder passing through the first passage (125) into the powder form. The pulverization part (130) comprises at least two of mesh members (131, 136) and operation units (132, 137).

In this example, for convenience of explanation, at least two mesh members (131, 136) will be referred to separately as “a first mesh member (131) and a second mesh member (136)”.

The first mesh member (131) and the second mesh member (136) have a network structure, which are operated to sieve the powder passing through the first passage (125). The first mesh member (131) and the second mesh member (136) are installed in the powder input part (120) so as to be movable in the first passage (125) in preset operating directions, respectively.

The first mesh member (131) and the second mesh member (136) are disposed apart from each other side by side along the longitudinal direction (L) of the first passage (125). The first mesh member (131) is located at the entry portion of the input direction of the powder.

Then, the second mesh member (136) is located at a portion through which the powder passing through the first mesh member (131) passes. The second mesh member (136) may have a network structure having openings equal to or smaller than the opening size of the first mesh member (131).

The operation units (132, 137) are devices coupled to the respective mesh members (131, 136) to move the respective mesh members in operating directions preset for each mesh member.

In this example, for convenience of explanation, the operation unit coupled to the first mesh member (131) is referred to as a “first operation unit (132)”. Then, the operation unit coupled to the second mesh member (136) is referred to as a “second operation unit (137)”.

The first operating unit (132) comprises a first guide rail (133) and a first operation member (134). The first guide rail (133) is installed on the inner side surface of the powder input part (120) in the longitudinal direction (L) of the first passage (125). The first guide rail (133) guides the movement of the first mesh member (131).

The first operation member (134) is coupled to the first mesh member (131). The first operation member (134) provides a driving force to the first mesh member (131). By the first operation member (134), the first mesh member (131) reciprocates up and down along the first guide rail (133) along the longitudinal direction (L) of the first passage (125).

The second operation unit (137) comprises a second guide rail (138) and a second operation member (139). The second guide rail (138) is installed on the inner side surface of the powder input part (120) in the longitudinal direction (L) of the first passage (125). The second guide rail (138) guides the movement of the second mesh member (136).

The second operation member (139) is coupled to the second mesh member (136). The second operation member (139) provides a driving force to the second mesh member (136). By the second operation member (139), the second mesh member (136) reciprocates up and down along the second guide rail (138) along the longitudinal direction (L) of the first passage (125).

In this example, the first operation member (134) and the second operation member (139) are preferably operated simultaneously. However, the first operation member (134) and the second operation member may operate the first mesh member (131) and the second mesh member (136) to move in directions different from each other.

Meanwhile, in this document, the operation member may be composed of a driving part such as a motor or a vibrator.

While the first operation member (134) and the second operation member (139) move the first mesh member (131) and the second mesh member (136) in directions different from each other, and accordingly the interval between the first mesh member (131) and the second mesh member (136) widens and narrows, it is possible to sieve the powder passing through the first mesh member (131) and the second mesh member (136).

As a result, as the pulverization part (130) pulverizes the agglomerated particles of the powder, the present invention can prevent clogging of the powder input part (120) by the agglomerated powder, and introduce the powder into the mixer body (110) at the input speed and input amount as preset.

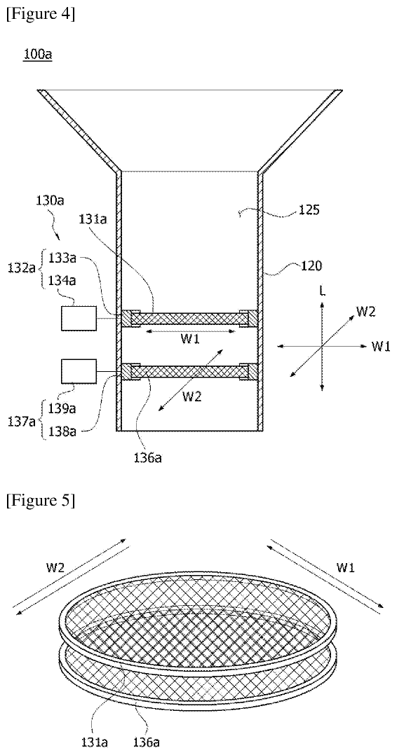

FIGS. 4 and 5 are diagrams for schematically explaining the configuration and operating state of a pulverization part according to a second example of the present invention.

Referring to FIGS. 4 and 5, the raw material mixing device (100a) for slurry preparation according to the second example includes a mixer body (110), a powder input part (120), and a pulverization part (130a). The raw material mixing device (100a) for slurry preparation according to the present example is different from the pulverization part (130) of the first example as described above in the structure and operation method of the pulverization part (130a). In this example, for convenience of explanation, descriptions of the mixer body (110) and the powder input part (120) having the same structure as in the first example will be omitted.

The pulverization part (130a) comprises a first mesh member (131a), a first operation unit (132a), a second mesh member (136a), and a second operation unit (137a). The first mesh member (131a) and the second mesh member (136a) are disposed apart from each other side by side along the longitudinal direction (L) of the first passage (125), and the first mesh member (131a) and the second mesh member (136a) are installed in the powder input part (120) so as to be movable along the width directions of the first passage (125) orthogonal to each other, respectively.

The first mesh member (131a) is installed to be reciprocally movable in a preset first width section in a first operating direction (W1) parallel to the width direction of the first passage (125). The first mesh member (131a) is located at the entry portion in the input direction of the powder. The first mesh member (131a) is coupled to the first operation unit (132a).

The first operation unit (132a) comprises a first width direction guide member (133a) and a first operation member (134a). The first width direction guide member (133a) is installed on the inner side surface of the powder input part (120) in the width direction of the first passage (125). The first width direction guide member (133a) guides the movement of the first mesh member (131a) in the first operating direction (W1).

The first operation member (134a) is coupled to the first mesh member (131a). The first operation member (134) provides a driving force to the first mesh member (131a). By the first operation member (134), the first mesh member (131a) is reciprocally moved along the first operation direction (W1), following the first width direction guide member (133a).

The second mesh member (136a) is installed to be reciprocally movable in a preset second width section in a second operating direction (W2) orthogonal to the first operating direction (W1). The second mesh member (136a) is located at a portion through which the powder passing through the first mesh member (131a) passes. The second mesh member (136a) is coupled to the second operation unit (137a).

The second operation unit (137a) comprises a second width direction guide member (138a) and a second operation member (139a). The second width direction guide member (138a) is installed on the inner side surface of the powder input part (120) in the width direction of the first passage (125).

The second width direction guide member (138a) guides the movement of the second mesh member (136a) in the second operating direction (W2). The second operating direction (W2) is a direction parallel to the width direction of the first passage (125), but orthogonal to the first operating direction (W1).

The second operation member (139a) is coupled to the second mesh member (136a). The second operation member (139a) provides a driving force to the second mesh member (136a). By the second operation member (139a), the second mesh member (136a) is reciprocally moved along the second operation direction (W2), following the second width direction guide member (138a).

Preferably, the first operation member (134a) and the second operation member (139a) are operated simultaneously. The first operation member (134a) and the second operation member may operate the first mesh member (131a) and the second mesh member (136a) to move in directions different from each other.

When the first operation member (134a) and the second operation member (139a) are operated, it is possible to pulverize the powder passing through the space between the first mesh member (131a) and the second mesh member (136a) while the first mesh member (131a) and the second mesh member (136a) are moved in directions orthogonal to each other.

By pulverizing the agglomerated powder so that the powder introduced into the mixer body (110) in the slurry preparation process is introduced in the form of powder, thereby uniformizing the powder particles applied in the slurry preparation process and shortening the input time of the powder, the present invention can improve the slurry preparation process.

As the powder is not agglomerated and is introduced into the mixer body (110) in the form of powder, and the input amount according to the input speed and input time of the powder is accurately calculated, thereby improving the formulation precision of raw materials constituting the slurry, the present invention can improve the slurry preparation process efficiency.

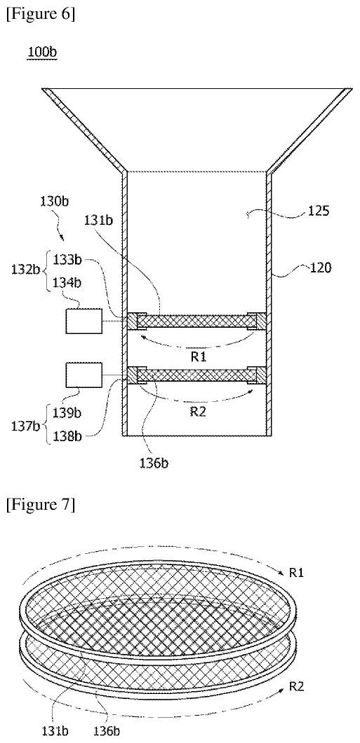

FIGS. 6 and 7 are diagrams for schematically explaining the configuration and operating state of a pulverization part according to a third example of the present invention.

Referring to FIGS. 6 and 7, the raw material mixing device (100b) for slurry preparation according to the second example comprises a mixer body (110), a powder input part (120), and a pulverization part (130b). The raw material mixing device (100b) for slurry preparation according to the present example is different from the pulverization part (130) of the first example as described above in the structure and operation method of the pulverization part (130b). In this example, for convenience of explanation, descriptions of the mixer body (110) and the powder input part (120) having the same structure as in the first example will be omitted.

The pulverization part (130b) comprises a first mesh member (131b), a second mesh member (136b), a first operation unit (132b), and a second operation unit (137b). The first mesh member (131b) and the second mesh (136b) are disposed apart from each other side by side along the longitudinal direction (L) of the first passage (125), and the first mesh member (131b) and the second mesh (136b) are each installed in the powder input part (120) so as to be rotationally movable in directions opposite to each other in the first passage (125).

The first mesh member (131b) is rotatably installed in the powder input part (120) along the circumferential direction of the first passage (125) in a first rotation direction (R1). The first mesh member (131b) is coupled to the first operation unit (132b).

The first operation unit (132b) comprises a first rotation guide member (133b) and a first operation member (134). The first rotation guide member (133b) is installed on the inner side surface of the powder input part (120) in the circumferential direction of the first passage (125). The first rotation guide member (133b) guides the movement of the first mesh member (131b).

The first operation member (134) is coupled to the first mesh member (131b). The first operation member (134) provides a driving force to the first mesh member (131b). The first mesh member (131b) receives the driving force from the first operation member (134) and is rotated in the first rotation direction (R1) following the first rotation guide member (133b).

The second mesh member (136b) is spaced apart from the first mesh member (131b) side by side, and installed in the powder input part (120) to be rotatable in a second rotation direction (R2) along the circumferential direction of the first passage (125). The second mesh member (136b) is coupled to the second operation unit (137b). The second rotation direction (R2) is a direction opposite to the first rotation direction (R1).

The second operation unit (137b) comprises a second rotation guide member (138b) and a second operation member (139a). The second rotation guide member (138b) is installed on the inner side surface of the powder input part (120) in the circumferential direction of the first passage (125). The second rotation guide member (138b) guides the movement of the second mesh member (136b).

The second operation member (139a) is coupled to the second mesh member (136b). The second operation member (139a) provides a driving force to the second mesh member (136b). The second mesh member (136b) receives the driving force from the second operation member (139a) to rotate in the second rotation direction (R2) following the second rotation guide member (138b).

When the first operation member (134b) and the second operation member (139b) are operated, it is possible to pulverize the powder passing through the space between the first mesh member (131b) and the second mesh member (136b) while the first mesh member (131b) and the second mesh member (136b) rotate in directions opposite to each other along the circumferential direction of the first passage (125).

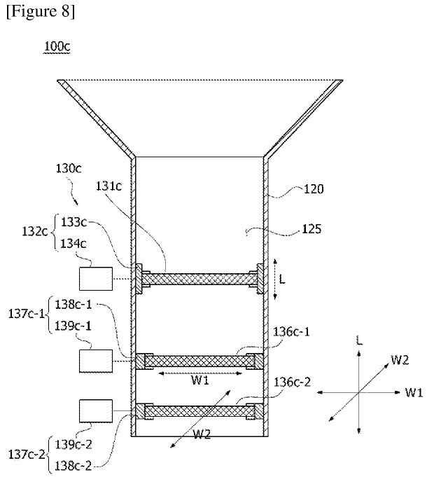

FIG. 8 is a diagram for schematically explaining the configuration and operating state of a pulverization part according to a fourth example of the present invention.

Referring to FIG. 8, the raw material mixing device (100c) for slurry preparation according to the fourth example comprises a mixer body (110), a powder input part (120), and a pulverization part (130c). The raw material mixing device (100c) for slurry preparation according to the present example is different from the pulverization part (130) of the first example in the structure and operation method of the pulverization part (130c). In this example, for convenience of explanation, descriptions of the mixer body (110) and the powder input part (120) having the same structure as in the first example will be omitted.

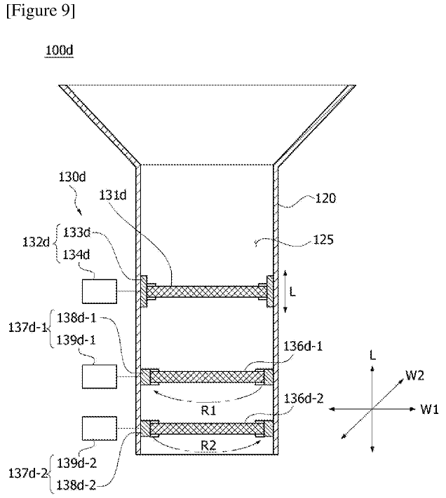

As shown in FIG. 9, the pulverization part (130c) comprises a first mesh member (131c), a 2a mesh member (136c-1), a 2b mesh member (136c-2), a first operation unit (132c), a 2a operation unit (137c-1), and a 2b operation unit (137c-2).

The first mesh member (131c), the 2a mesh member (136c-1), and the 2b mesh member (136c-2) are sequentially disposed apart from each other side by side in the first passage (125) along the input direction of the powder.

The first operation unit (132c) is coupled to the first mesh member (131c). The first operation unit (132c) comprises a first guide rail (133c) and a first operation member (134c). The first guide rail (133c) is installed on the inner side surface of the powder input part (120) in the longitudinal direction (L) of the first passage (125). The first guide rail (133c) guides the movement of the first mesh member (131c).

The first operation member (134c) is coupled to the first mesh member (131c). The first operation member (134c) provides a driving force to the first mesh member (131c). When the first operation member (134c) is operated, the first mesh member (131c) reciprocates up and down along the longitudinal direction (L) of the first passage (125) following the first guide rail (133c).

The 2a mesh member (136c-1) and the 2b mesh member (136c-2) are disposed apart from each other side by side along the longitudinal direction (L) of the first passage (125), but installed in the powder input part (120) to be movable along the width directions orthogonal to each other within the first passage (125).

The 2a mesh member (136c-1) is installed to be reciprocally movable in the preset first width section in the first operating direction (W1) parallel to the width direction of the first passage (125). The 2a mesh member (136c-1) is located at the entry portion of the powder input direction. The 2a mesh member (136c-1) is coupled to the 2a operation unit (137c-1).

The 2a operation unit (137c-1) comprises a 2a width direction guide member (138c-1) and a 2a operation member (139c-1). The 2a width direction guide member (138c-1) is installed on the inner side surface of the powder input part (120) in the width direction of the first passage (125). The 2a width direction guide member (138c-1) guides the movement of the 2a mesh member (136c-1) in the first operating direction (W1).

The 2a operation member (139c-1) is coupled to the 2a mesh member (136c-1). The 2a operation member (139c-1) provides a driving force to the 2a mesh member (136c-1). By the 2a operation member (139c-1), the 2a mesh member (136c-1) reciprocates along the first operation direction (W1) following the 2a width direction guide member (138c-1).

The 2b mesh member (136c-2) is installed to be reciprocally movable in a preset second width section in the second operating direction (W2) orthogonal to the first operating direction (W1). The 2b mesh member (136c-2) is located at a portion through which the powder passing through the 2a mesh member (136c-1) passes. The 2b mesh member (136c-2) is coupled to the 2b operation unit (137c-2).

The 2b operation unit (137c-2) comprises a 2b width direction guide member (138c-2) and a 2b operation member (139c-2). The 2b width direction guide member (138c-2) is installed on the inner side surface of the powder input part (120) in the width direction of the first passage (125).

The 2b width direction guide member (138c-2) guides the movement of the 2b mesh member (136c-2) in a second operating direction (W2). The second operating direction (W2) is a direction parallel to the width direction of the first passage (125), but orthogonal to the first operating direction (W1).

The 2b operation member (139c-2) is coupled to the 2b mesh member (136c-2). The 2b operation member (139c-2) provides a driving force to the 2b mesh member (136c-2). By the 2b operation member (139c-2), the 2b mesh member (136c-2) reciprocates along the second operating direction (W2) following the 2b width direction guide member (138c-2).

Preferably, the 2a operation member (139c-1) and the 2b operation member (139c-2) are operated simultaneously. The 2a operation member (139c-1) and the 2a operation member (139c-2) may operate the 2a mesh member (136c-1) and the 2b mesh member (136c-2) to move in directions different from each other.

When the 2a operation member (139c-1) and the 2b operation member (139c-2) are operated, it is possible to pulverize the powder passing through the space between the 2a mesh member (136c-1) and the 2b mesh member (136c-2) while the 2a mesh member (136c-1) and the 2b mesh member (136c-2) are moved in directions orthogonal to each other.

When the first operation member (134c), the 2a operation member (139c-1) and the 2b operation member (139c-2) are simultaneously operated, it is possible to sieve the powder passing through the first passage (125) while the interval between the first mesh member (131c) and the 2a mesh member (136c-1) narrows and then widens, and as the 2a mesh member (136c-1) and the 2b mesh member (136c-2) are parallel to each other, but are operated so that the operating directions are orthogonal to each other, it is possible to pulverize the powder passing through the first passage (125).

FIG. 9 is a diagram for schematically explaining the configuration and operating state of a pulverization part according to a fifth example of the present invention.

Referring to FIG. 9, the raw material mixing device (100d) for slurry preparation according to the fifth example comprises a mixer body (110), a powder input part (120), and a pulverization part (130d). The raw material mixing device (100d) for slurry preparation according to the present example is different from the pulverization part (130) of the first example in the structure and operation method of the pulverization part (130d). In this example, for convenience of explanation, descriptions of the mixer body (110) and the powder input part (120) having the same structure as in the first example will be omitted.

Referring to FIG. 9, the pulverization part (130d) comprises a first mesh member (131d), a 2a mesh member (136d-1), a 2b mesh member (136d-2), a first operation unit (132d), a 2a operation unit (137d-1), and a 2b operation unit (137d-2).

The first mesh member (131d), the 2a mesh member (136d-1), and the 2b mesh member (136d-2) are disposed apart from each other side by side in the first passage (125) along the input direction of the powder.

The first operation unit (132d) is coupled to the first mesh member (131d). The first operation unit (132d) comprises a first guide rail (133d) and a first operation member (134d). The first guide rail (133d) is installed on the inner side surface of the powder input part (120) in the longitudinal direction (L) of the first passage (125). The first guide rail (133d) guides the movement of the first mesh member (131d).

The first operation member (134d) is coupled to the first mesh member (131d). The first operation member (134d) provides a driving force to the first mesh member (131d). By the first operation member (134d), the first mesh member (131d) reciprocates up and down along the longitudinal direction (L) of the first passage (125) following the first guide rail (133d).

The 2a mesh member (136d-1) and the 2b mesh member (136d-2) are disposed apart from each other along the longitudinal direction (L) of the first passage (125), but installed in the powder input part (120) so as to be rotatably movable in directions opposite to each other along the width direction of the first passage (125).

The 2a mesh member (136d-1) is installed in the powder input part (120) to be rotatably movable in the first rotation direction (R1) (e.g., clockwise direction) along the circumferential direction of the first passage (125). The 2a mesh member (136d-1) is coupled to the 2a operation unit (137d-1).

The 2a operation unit (137d-1) comprises a 2a rotation guide member (138d-1) and a 2a operation member (139d-1). The 2a rotation guide member (138d-1) is installed on the inner side surface of the powder input part (120) in the circumferential direction of the first passage (125). The 2a rotation guide member (138d-1) guides the movement of the 2a mesh member (136d-1).

The 2a operation member (139d-1) is coupled to the 2a mesh member (136d-1). The 2a operation member (139d-1) provides a driving force to the 2a mesh member (136d-1). The 2a mesh member (136d-1) receives the driving force from the 2a operation member (139d-1) and rotates clockwise along the 2a rotation guide member (138d-1).

The 2b mesh member (136d-2) is spaced apart from the 2a mesh member (136d-1) side by side, and installed in the powder input part (120) to be rotatable in the second rotation direction (R2) (e.g., counterclockwise) along the circumferential direction of the first passage (125). The 2b mesh member (136d-2) is coupled to the 2b operation unit (137d-2). The second rotation direction (R2) is a direction opposite to the first rotation direction (R1).

The 2b operation unit (137d-2) comprises a 2b rotation guide member (138d-2) and a 2b operation member (139d-2). The 2b rotation guide member (138d-2) is installed on the inner side surface of the powder input part (120) in the circumferential direction of the first passage (125). The 2b rotation guide member (138d-2) guides the movement of the 2b mesh member (136d-2).

The 2b operation member (139d-2) is coupled to the 2b mesh member (136d-2). The 2b operation member (139d-2) provides a driving force to the 2b mesh member (136d-2). The 2b mesh member (136d-2) receives the driving force from the 2b operation member (139d-2) and rotates counterclockwise along the 2b rotation guide member (138d-2).

When the 2a operation member (139d-1) and the 2b operation member (139d-2) are operated, it is possible to pulverize the powder passing through the space between the 2a mesh member (136d-1) and the 2b mesh member (136d-2) while the 2a mesh member (136d-1) and the 2b mesh member (136d-2) rotate in directions opposite to each other along the circumferential direction of the first passage (125).

When the first operation member (134d), the 2a operation member (139d-1) and the 2b operation member (139d-2) are simultaneously operated, it is possible to sieve the powder passing through the first passage (125) while the interval between the first mesh member (131d) and the second mesh member (136d) narrows and then widens, and it is possible to pulverize the powder passing through the first passage (125) while a pair of second mesh members (136d) rotates in directions parallel to each other, but opposite to each other.

One example of the present invention as described above has been disclosed for illustrative purposes, and those skilled in the art having ordinary knowledge of the present invention will be able to make various modifications, changes, and additions within the spirit and scope of the present invention, and such modifications, changes, and additions should be regarded as falling within the scope of the following claims.

### Industrial Applicability

According to the raw material mixing device for slurry preparation in accordance with one example of the present invention, it is possible to uniformize powder particles introduced into the slurry preparation process, and by shortening the input time of the powder, it is possible to improve the slurry preparation process efficiency.

1. A raw material mixing device for slurry preparation comprising:
a mixer body in which powder-containing raw materials for forming a slurry are configured to be mixed;
a powder input part provided in the mixer body and having a first passage through which the powder is configured to move to the mixer body; and
a pulverization part including a plurality of mesh members disposed apart from each other in the first passage and operation units coupled to respective ones of the plurality of mesh members and configured to move the respective ones of the plurality of mesh members in preset operating directions, the pulverization part configured to pulverize the powder passing through the first passage while the respective mesh members move in directions different from each other.

2. The raw material mixing device for slurry preparation according to claim 1, wherein
each of the plurality of mesh members is provided in the powder input part to be movable in at least one direction of: a longitudinal direction of the first passage, a width direction of the first passage, or a circumferential direction of the first passage.

3. The raw material mixing device for slurry preparation according to claim 1, wherein
the plurality of mesh members comprises first and second mesh members, where
the first and second mesh members are each installed in the powder input part to be movable in directions opposite to each other along the longitudinal direction of the first passage, and
an interval between the first and second mesh members is configured to be adjusted.

4. The raw material mixing device for slurry preparation according to claim 3, wherein
the pulverization part comprises: a first guide rail guiding movement of the first mesh member and installed on an inner side surface of the powder input part in a longitudinal direction of the first passage;
a first operation member configured to provide a driving force to the first mesh member;
a second guide rail guiding movement of the second mesh member, disposed apart from the first guide rail, and installed on the inner side surface of the powder input part in the longitudinal direction of the first passage; and
a second operation member configured to provide a driving force to the second mesh member, where
the first operation member and the second operation member are configured to operate the first mesh member and the second mesh member, respectively, so that the first mesh member and the second mesh member move in directions different from each other.

5. The raw material mixing device for slurry preparation according to claim 1, wherein
the plurality of mesh members comprises first and second mesh members, where
the first and second mesh members are each installed in the powder input part to be reciprocally movable in a width direction of the first passage in a first width section and a second width section divided orthogonally to each other in the first passage, and
the first and second mesh members are each configured to be moved in the width direction of the first passage so that the first and second mesh members are parallel to each other, but are configured to be moved orthogonal to each other.

6. The raw material mixing device for slurry preparation according to claim 5, wherein
the pulverization part comprises: a first width direction guide member guiding movement of the first mesh member and installed on an inner side surface of the powder input part in the first width section;
a first operation member configured to provide a driving force to the first mesh member;
a second width direction guide member guiding movement of the second mesh member and installed on the inner side surface of the powder input part in the second width section; and
a second operation member configured to provide a driving force to the second mesh member, where
the first operation member is configured to operate the first mesh member to reciprocate the first width section, and the second operation member is configured to operate the second mesh member to reciprocate the second width section.

7. The raw material mixing device for slurry preparation according to claim 1, wherein
the plurality of mesh members comprises first and second mesh members, where
the first and second mesh members are each installed in the powder input part to be rotatable in directions opposite to each other along a circumferential direction of the first passage, and
the first and second mesh members are configured to be rotated in directions parallel to each other, but opposite to each other.

8. The raw material mixing device for slurry preparation according to claim 7, wherein the pulverization part comprises:
a first rotation guide member configured to guide rotation of the first mesh member and installed on an inner side surface of the powder input part along the circumference of the first passage;
a first operation member configured to provide a rotational force to the first mesh member so that the first mesh member is rotated in a first rotation direction as preset;
a second rotation guide member configured to guide rotation of the second mesh member and installed on the inner side surface of the powder input part to be disposed apart from the first rotation guide member side by side; and
a second operation member configured to provide a rotational force to the second mesh member so that the second mesh member is rotated in a second rotation direction opposite to the first rotation direction.

9. The raw material mixing device for slurry preparation according to claim 1, wherein
the plurality of mesh members comprises: a first mesh member installed in the powder input part to be movable in a longitudinal direction of the first passage; and
a pair of second mesh members disposed apart from the first mesh member in the longitudinal direction of the first passage, but each of the pair of second mesh members installed in the powder input part to be reciprocally movable in a width direction of the first passage in a first width section and a second width section divided orthogonally to each other in the first passage.

10. The raw material mixing device for slurry preparation according to claim 9, wherein
the pair of second mesh members comprises a 2a mesh member reciprocating in the first width section and a 2b mesh member reciprocating in the second width section, and
the pulverization part comprises: a first guide rail configured to guide movement of the first mesh member and installed on an inner side surface of the powder input part in the longitudinal direction of the first passage;
a first operation member providing a driving force to the first mesh member;
a 2a width direction guide member configured to guide movement of the 2a mesh member and installed on the inner side surface of the powder input part in the first width section of the first passage;
a 2a operation member configured to provide a driving force to the 2a mesh member;
a 2b width direction guide member configured to guide movement of the 2b mesh member and installed on the inner side surface of the powder input part in the second width section; and
a 2b operation member configured to provide a driving force to the 2b mesh member.

11. The raw material mixing device for slurry preparation according to claim 10, wherein
the first operation member is configured to reciprocate the first mesh member along the first guide rail in the longitudinal direction of the first passage, and
the 2a operation member and the 2b operation member are configured to reciprocate the 2a mesh member and the 2b mesh member in directions parallel to each other, but orthogonal to each other.

12. The raw material mixing device for slurry preparation according to claim 1, wherein
the plurality of mesh members comprises: a first mesh member installed in the powder input part to be movable in the longitudinal direction of the first passage; and
a pair of second mesh members disposed apart from the first mesh member in the longitudinal direction of the first passage, and installed in the powder input part to be rotatable along the circumference of the first passage.

13. The raw material mixing device for slurry preparation according to claim 12, wherein
the pair of second mesh members comprises a 2a mesh member and a 2b mesh member, and
the pulverization part comprises: a first guide rail configured to guide movement of the first mesh member and installed on an inner side surface of the powder input part in the longitudinal direction of the first passage;
a first operation member configured to provide a driving force to the first mesh member;
a 2a rotation guide member configured to guide rotation of the 2a mesh member and installed on the inner side surface of the powder input part along the circumference of the first passage;
a 2a operation member configured to provide a rotational force to the 2a mesh member so that the 2a mesh member rotates in a first rotation direction as preset;
a 2b rotation guide member configured to guide rotation of the 2b mesh member, disposed apart from the 2a rotation guide member side by side, and installed on the inner side surface of the powder input part along the circumference of the first passage; and
a 2b operation member configured to provide a rotational force to the 2b mesh member so that the 2b mesh member rotates in a second rotation direction opposite to the first rotation direction.

14. The raw material mixing device for slurry preparation according to claim 13, wherein
the first operation member is configured to reciprocate the first mesh member along the first guide rail in the longitudinal direction of the first passage, and
the 2a operation member and the 2b operation member configured to operate the 2a mesh member and the 2b mesh member to rotate in directions parallel to each other, but opposite to each other.

15. The raw material mixing device for slurry preparation according to claim 1, wherein
the plurality of mesh members comprises a first mesh member having a network structure including first openings and a second mesh member having a network structure including second openings having an opening area smaller than the first opening area, and
the second mesh member is installed in a portion of the first passage through which the powder passing through the first mesh member passes.
